(19) United States
(12) Patent Application Publication
(10) Pub. No.: US 2007/0024093 A1
(43) Pub. Date: Feb. 1, 2007

(54) Carriage system of a shiftable sunshade in a motor vehicle

(76) Inventors: Rainer Grimm, Frankfurt (DE); Joachim Roeder, Muehlheim (DE); Claudia Riess, Lichtenberg (DE); Manfred Roehnke, Roedermark (DE)

Correspondence Address: CARLSON, GASKEY & OLDS, P.C., 400 WEST MAPLE ROAD, SUITE 350, BIRMINGHAM, MI, 48009, US

(21) Appl. No.: 11/489,818

(22) Filed: Jul. 20, 2006

(30) Foreign Application Priority Data
Jul. 28, 2005 (EP) 05 016 404.5

(51) Int. Cl. B60J 7/00

(52) U.S. Cl. 296/214

(57) ABSTRACT

A carriage system of a sunshade in a motor vehicle includes a carriage having a guiding piece and a connecting piece. The guiding piece is coupled to the connecting piece such that the connecting piece may be released in a nondestructive manner.

### RELATED APPLICATIONS

The application claims priority to European Patent Application No. 05 016 404.5 which was filed on Jul. 28, 2005.

### BACKGROUND OF THE INVENTION

The invention relates to a carriage system of a shiftable sunshade in a motor vehicle. A carriage system is a wheeled or sliding vehicle part supporting some other movable object running along and fixed to a guide, e.g. a rail.

Sunshade systems such as roller blinds or sliding headliners, which for example are used in combination with a sliding roof or a glass roof, are offered in a manually actuatable and in an electrically driven form.

In the electrically driven variant, a crossbar of the roller blind is connected to a drive cable extending in a guide rail. The position of the crossbar of the roller blind is determined by the movement of a rigidly guided cable in the guide rail by a motor. For manually actuated roller blinds, the crossbar is moved by hand, with ends of the crossbar being guided by carriages received in the guide rail.

The invention improves cost effectiveness of a sunshade system compared to prior configurations.

### SUMMARY OF THE INVENTION

A carriage system of a sunshade for a motor vehicle includes a carriage having a guiding piece and a connecting piece for connection to the sunshade. The guiding piece is coupled to the connecting piece such that the connecting piece may be released in a nondestructive manner. The guiding piece is a component separate from the connecting piece. Thus, it is possible to use a basic form of the carriage for both manually actuated and electrically driven sunshade systems. In this way, it is further possible to dismount the sunshade in a simple manner since the connecting piece may be uncoupled from the guiding piece, whereby the connecting piece can be removed from a guide rail with the guiding piece remaining in the guide rail.

If an electric drive system is provided for the sunshade, the guiding piece is preferably connected to a drive cable. Thus, it is possible to remove the connecting piece and a sunshade connected thereto without having to remove a drive system, if any, since the drive cable may remain in the guide rail along with the guiding piece.

Preferably, a latching element is formed on the guiding piece and configured such that the latching element may establish a latching connection with a latching portion formed on the connecting piece. The latching connection fastens the guiding piece to the connecting piece.

When using an electric drive, one end of the drive cable is preferably non-releasably connected to the guiding piece, for example by potting or by encasing by injection molding.

The sunshade is preferably a roller blind. It is, however, also possible to use a sliding headliner.

As the carriage is normally received in a guide rail, the latching connection is advantageously closed in a shifting direction of the carriage.

The latching element may for example have a tongue that is deflectable in a direction perpendicular to the shifting direction. The deflection of this tongue may be used for both establishing and releasing the latching connection.

When the carriage is arranged in the guide rail, the guide rail preferably secures the guiding piece and the connecting piece to each other transversely to the shifting direction, and can also prevent a releasing of the latching connection in a direction perpendicular to the shifting direction. The guide can then act in a z-direction of the vehicle as well as in a y-direction of the vehicle, both directions being perpendicular to the shifting direction of the carriage in an x-direction of the vehicle.

In a preferred embodiment, the latching element is formed integrally with the guiding piece.

The realization of the latching element being integral with the guiding piece, and the simple connection of the cable to the guiding piece, are particularly simple when at least the guiding piece, but preferably the whole carriage, is made from a suitable plastic material.

These and other features of the present invention can be best understood from the following specification and drawings, the following of which is a brief description.

### BRIEF DESCRIPTION OF THE DRAWINGS

FIG. 1 shows a schematic view of a carriage system according to the invention.

FIG. 2 shows a three-dimensional view of a carriage system according to the invention.

FIG. 3 shows another view of the carriage system according to the invention.

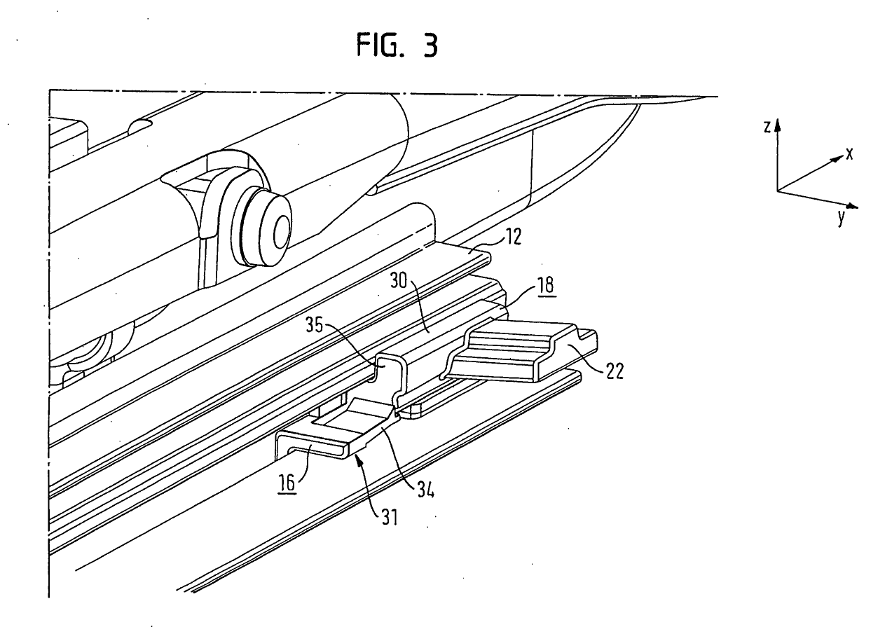

FIG. 4 shows another view of the carriage system.

FIG. 5 shows a view of a guiding piece of a carriage system according to the invention.

FIG. 6 shows another view of the guiding piece of a carriage system according to the invention.

FIG. 7 shows another view of the guiding piece of a carriage system according to the invention.

FIG. 8 shows another view of the guiding piece of a carriage system according to the invention.

FIG. 9 shows another view of the guiding piece of a carriage system according to the invention.

FIG. 10 shows a perspective view of a carriage system according to the invention.

### DETAILED DESCRIPTION OF THE PREFERRED EMBODIMENT

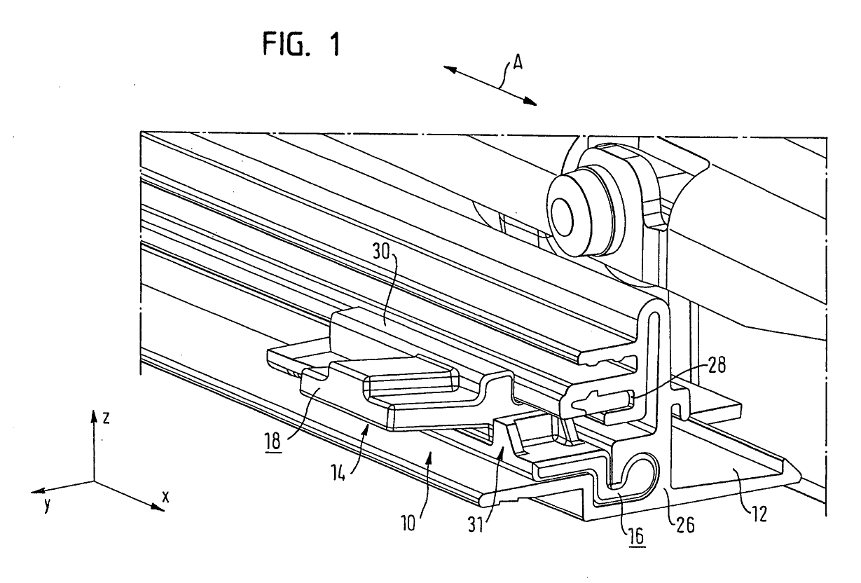

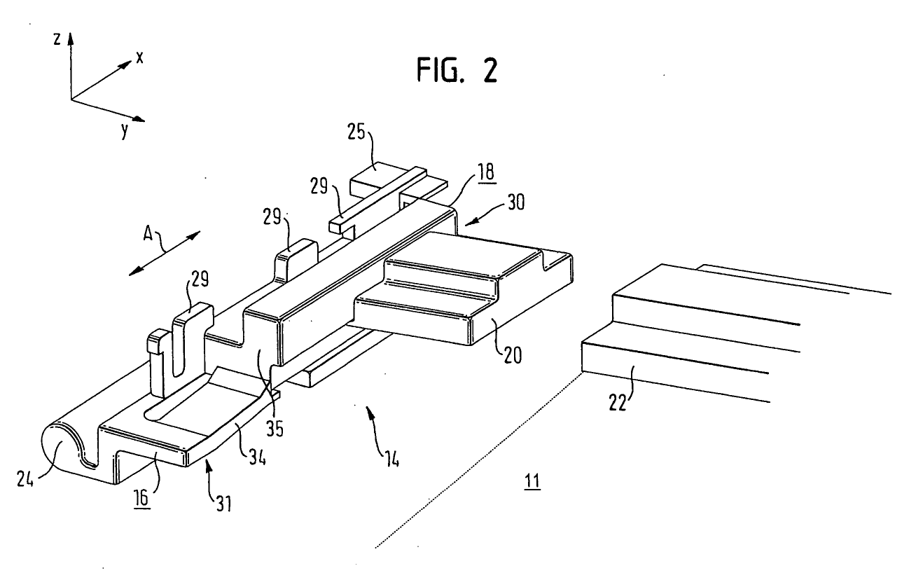

FIG. 1 represents a carriage system 10 that serves to move a sunshade in the form of a roller blind 11 (FIG. 2) in a motor vehicle. In most cases, such a roller blind 11 usually is arranged below a sliding roof (not represented) of the vehicle.

Several guides are formed in two guide rails 12 only one of which is show. The guides extend parallel to each other in a longitudinal direction of the vehicle along a roof. A carriage 14 is received in the guide rail 12 and is shiftable in a shifting direction A. The carriage 14 includes two parts, namely a guiding piece 16 and a connecting piece 18. This is shown in more detail in FIG. 2.

The connecting piece 18 comprises an extension 20 that is oriented perpendicularly to the shifting direction A. A crossbar 22 of the roller blind 11 may be put on the extension 20, as indicated in FIG. 2.

The guiding piece 16 comprises a thickened portion 24 that extends in the shifting direction A and is arranged on a longitudinal side of the carriage 14. The thickened portion 24 is received in a first guide 26 of the guide rail 12. The guiding piece 16 is movable only in the shifting direction A, but is not movable in any other direction (i.e. in the z-direction or in the y-direction).

The connecting piece 18 also comprises a protrusion 25 which is received in a second guide 28 when the carriage 14 is assembled, the second guide 28 being located above the first guide 26. The protrusion 25 is arranged on the same side of the carriage 14 as the thickened portion 24. Further protrusions 29, which are perpendicular to the shifting direction A as well as to a direction of the protrusion 25 (i.e. which are oriented in a z-direction), are also received in the second guide 28. The protrusions 29 also prevent a movement of the carriage 14 in a direction perpendicular to the shifting direction A.

The connecting piece 18 is firmly connected to the guiding piece 16 via a latching connection.

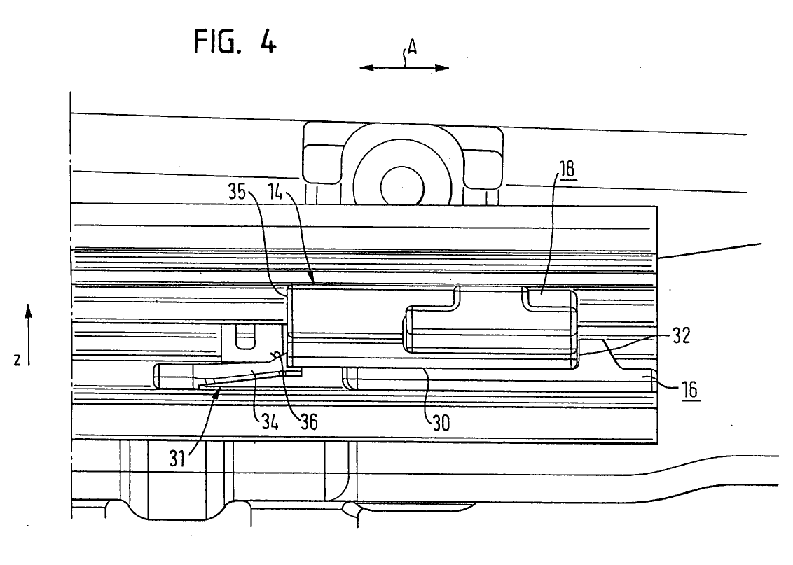

As shown in the example of FIG. 4, the connecting piece 18 has a block-shaped latching portion 30 that serves to fasten the connecting piece 18 to the guiding piece 16. The guiding piece 16 comprises a latching element 31 that is complementary to the latching portion 30. A stop 32 resting against a front end face of the latching portion 30 of the connecting piece 18 forms a first portion of the latching element 31. An abutment surface is formed on a tongue 34 of the guiding piece 16. The abutment surface engages a second portion of the latching element 31 that comprises a rear end face 35 of the latching portion 30. The tongue 34 is deflectable only in the z-direction and comprises an oblique deflection face 36 on its end facing away from the latching portion 30. In the z-direction, a space is recessed below the tongue 34 so that this tongue 34 may move freely along a sufficient stroke.

Starting from the side of the tongue 34, the connecting piece 18 may thus be slipped on the guiding piece 16 in the shifting direction A, the tongue 34 being deflected downwards in a negative z-direction due to the contact of the connecting piece 18 with the deflection face 36. When the rear end face 35 of the latching portion 30 of the connecting piece 18 has passed the deflection face 36, the tongue 34 pivots back in the positive z-direction and, with the abutment surface, fastens the latching portion 30 and thus the connecting piece 18.

For releasing the latching connection, the tongue 34 is pressed down in the negative z-direction, for example by using a suitable tool such as a screw driver, and the connecting piece 18 is moved against the shifting direction A until the connecting piece 18 is released from the latching connection. The connecting piece 18, along with the crossbar 22 fastened thereon and the roller blind 11 hanging thereon, can now be moved in the guide rail 12 independently of the guiding piece 16, and can finally be removed from the guide rail 12 at a front end thereof. The guide rail 12 may for example have an assembling or disassembling point (not shown), which is formed such that the carriage 14 may be raised out of the guide rail 12 perpendicularly to the shifting direction A, for example in the z-direction. Alternatively, the removal of the carriage 14 may occur in the shifting direction A.

The carriage 14 described above is provided for use with a manually actuated sunshade.

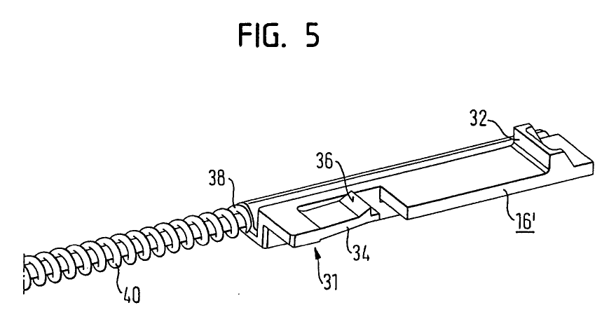

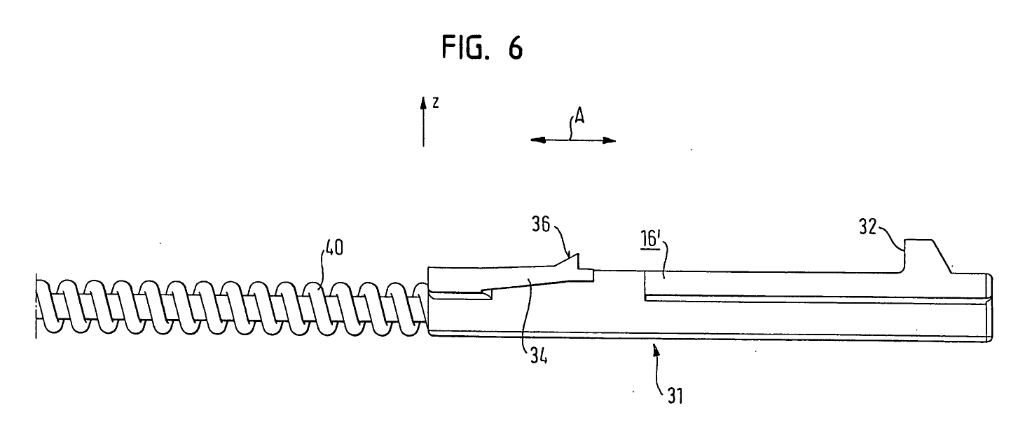

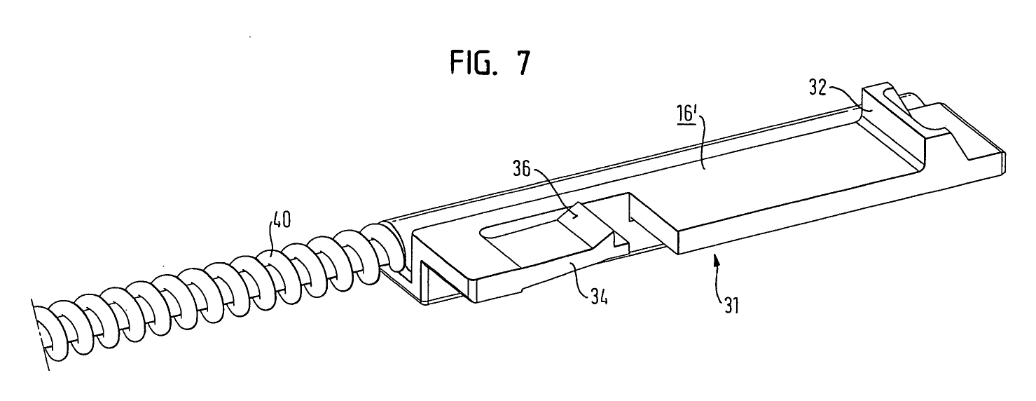

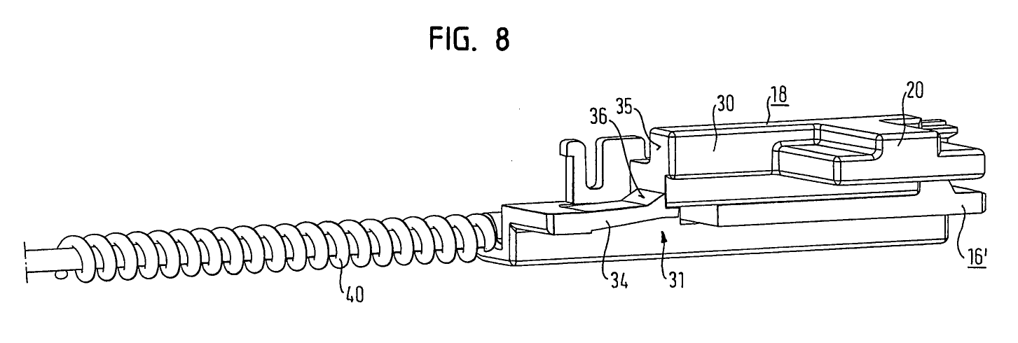

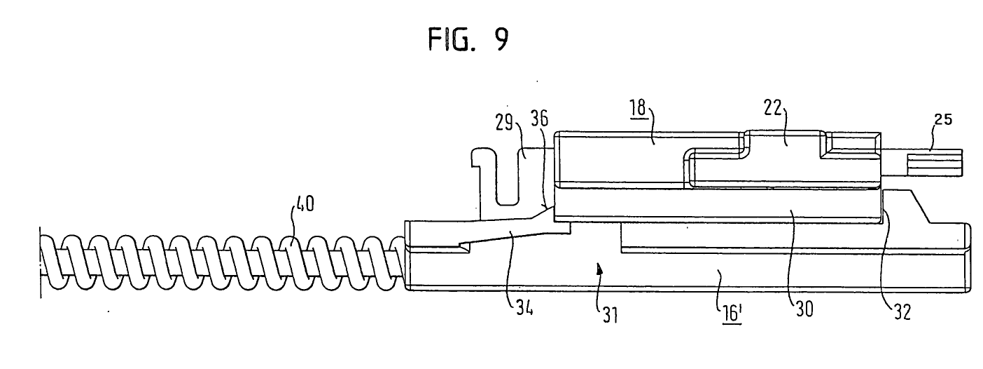

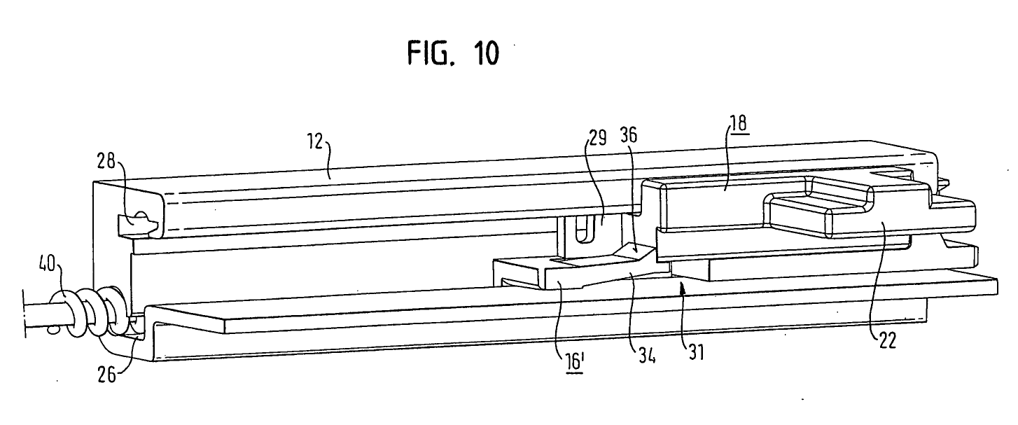

In the embodiment shown in the FIGS. 5 to 10, one end 38 of a drive cable 40 through which an electric drive (not shown) may move the carriage 14, and thus the roller blind 11, is mounted on an axial end of guiding piece 16′. Apart from that, the guiding piece 16′ is identical with the guiding piece 16 described above. An identical connecting piece 18 may be used in both cases.

The end 38 of the drive cable 40, which is formed in a known manner, is preferably received integrally within the guiding piece 16′. This may for example be realized by potting, by encasing, or by injection molding. The cable 40 is thus non-releasably connected to the guiding piece 16′.

If it is, for example, necessary to replace the roller blind 11, the drive cable 40, along with the guiding piece 16′ fastened thereon, can remain in the guide rail 12 whereas the connecting piece 18 is removed from the guide rail 12 after the releasing of the latching connection.

In this example, the complete carriage 14, comprising the guiding piece 16, 16′ as well as the connecting piece 18, is made from plastic material and both parts are injection molded.

Of course, the latching connection may also be realized by an inversed configuration in which the latching portion described is formed on the guiding piece 16, 16′ and the latching element on the connecting piece 18. Generally speaking, a first latching element is provided on the guiding piece 16 and a second complementary latching element is provided on the connecting piece 18 that may establish a releasable latching connection, which firmly, but releasably couples to each other the guiding piece 16 and the connecting piece 18 together forming the carriage 14.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A carriage system of a shiftable sunshade in a motor vehicle comprising:
a carriage having a guiding piece and a connecting piece for connection to the shiftable sunshade, wherein the guiding piece is coupled to the connecting piece such that the connecting piece is released in a nondestructive manner.

2. The carriage system according to claim 1 including a latching element formed on the guiding piece, the latching element being configured such that the latching element establishes a latching connection with a complementary latching portion formed on the connecting piece, the latching connection fastening the guiding piece to the connecting piece.

3. The carriage system according to claim 1 including a drive cable that is connected to the guiding piece.

4. The carriage system according to claim 3 wherein one end of the drive cable is non-releasably connected to the guiding piece.

5. The carriage system according to claim 1 wherein the shiftable sunshade is a roller blind.

6. The carriage system according to claim 2 wherein the latching connection is closed in a shifting direction of the carriage.

7. The carriage system according to claim 2 wherein the latching element comprises a tongue which is deflectable in a direction perpendicular to a shifting direction.

8. The carriage system according to claim 1 wherein the carriage is arranged in a guide rail and the guide rail secures the guiding piece and the connecting piece to each other transversely to a shifting direction.

9. The carriage system according to claim 8 wherein the guide rail prevents a releasing of a latching connection between the guiding piece and the connecting piece in a direction perpendicular to the shifting direction.

10. The carriage system according to claim 2 wherein the latching element is formed integrally with the guiding piece.

11. The carriage system according to claim 1 wherein the carriage is made from a plastic material.
